(19) United States
(12) Patent Application Publication
(10) Pub. No.: US 2026/0012878 A1
(43) Pub. Date: Jan. 8, 2026

(54) SYSTEM AND METHOD FOR MANAGING MESSAGES IN A NETWORK

(71) Applicant: JIO PLATFORMS LIMITED, Ahmedabad (IN)

(72) Inventors: Aayush BHATNAGAR, Navi Mumbai (IN); Arun DEWNA, Hathoj (IN); Aarthi MUTHUPANDI, Kalyan West (IN); Vivek KUMAR, Kaushambi (IN); Anish JAIN, Dungarpur (IN); Anushka RAWAT, Delhi (IN)

(73) Assignee: JIO PLATFORMS LIMITED, Ahmedabad (IN)

(21) Appl. No.: 18/992,116

(22) PCT Filed: Apr. 12, 2024
(86) PCT No.: PCT/IN2024/050386

§ 371 Date: Jan. 7, 2025

(30) Foreign Application Priority Data
Apr. 29, 2023 (IN) 202321030832

(51) Int. Cl. H04W 48/02; H04L 51/212; H04L 51/58; H04W 84/04

(52) U.S. Cl. CPC H04W 48/02; H04L 51/212; H04L 51/58; H04W 84/042

(57) ABSTRACT

The present disclosure provides a system and a method for managing messages in a network. The system generates cell-identification (ID) barring in networks for restricting users (102) from sending and receiving messages in the network. Further, the system provides an efficient way to handle a logical barring of the devices from sending and receiving the messages. The system facilitates the barring of selective users in a defined cell-ID of a public land mobile network (PLMN), and therefore, provides flexibility while managing messages in the network. The system verifies if a mobile originating/mobile terminating (MO/MT) message is barred in the defined cell-ID in the PLMN and processes the MO/MT message based on the verification.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to systems and methods for cell identification (ID) barring, thereby restricting users from sending and receiving messages in a network. More particularly, the present disclosure relates to a system and a method for managing messages in the network.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

In cellular mobile systems, access to a network is performed via a shared resource medium, known as a random access channel (RACH). In case a user equipment (UE) initiates a voice call, the UE first contacts the network via the RACH and subsequently receives a traffic channel allocation. In order to prevent UEs from accessing an overloaded cell, various features have been provided as a part of the third generation partnership project (3GPP). However, conventional systems are complex and do not provide an efficient system for handling messages.

There is, therefore, a need in the art to provide a system and a method that can mitigate the problems associated with the prior arts.

### SUMMARY

In an exemplary embodiment, A method for cell identification (ID) barring to restrict one of plurality of users from sending and receiving messages in a network by a short message service function (SMSF) is described. The method comprises receiving a mobile originating/mobile terminating (MO/MT) request from one user of the plurality of users. The request includes a general public subscription identifier (GPSI) of the user. The method further comprises determining whether the user is included in a global whitelist using a data structure global whitelisting (DS-GW) flag. When the DS-GW flag is set to true, the user is included in the global whitelist and when the DS-GW flag is set to false, the user is not included in the global whitelist. The method comprises on determining that the user is included in the global whitelist, allowing the MO/MT message and on determining that the user is not included in the global whitelist, deriving a public land mobile network (PLMN) identification (ID) from the MO/MT request. The PLMN-ID include combination of a mobile country code (MCC), a mobile network code (MNC), a tracking area code (TAC). The method further comprises verifying whether the MO/MT message is barred in a defined cell ID from a plurality of cell IDs in the PLMN using a data structure-cell blacklisted (DS-CELLB). The method comprises on determining that the MO/MT message is barred in the defined cell ID from plurality of cell IDs in the PLMN, barring the MO/MT message. On determining that the MO/MT message is not barred in the defined cell ID from the plurality of cell IDs in the PLMN, allowing the MO/MT message.

In some embodiments, the method further comprises creating a dynamic counter for counting a number of MO/MT blocking due to the management blocking for each profile value, wherein the dynamic counter is used for home subscribers and international roamers.

In some embodiments, the dynamic counter is created based on one of an originating PLMN for MO, a terminating PLMN for MT, per international roamer PLMN to provide the values for MO attempted, MT attempted, MO success, MT success, activation attempted, activation success, MO blocked, MT blocked, context get and combination.

In some embodiments, the method further comprises determining whether the PLMN is whitelisted, or block listed for the MO/MT request by using a data structure-public land mobile network whitelisted (DS-PLMNW) or a data structure-public land mobile network blacklisted (DS-PLMNB).

In another exemplary embodiment, a system for cell identification (ID) barring to restrict one of plurality of users from sending and receiving messages in a network is described. The system comprises a short message service function (SMSF). The SMSF is configured to receive a mobile originating/mobile terminating (MO/MT) request from one user of the plurality of users. The request includes a general public subscription identifier (GPSI) of the user. The SMSF is further configured to determine whether the user is included in a global whitelist using a data structure global whitelisting (DS-GW) flag. When the DS-GW flag is set to true, the user is included in the global whitelist and when the DS-GW flag is set to false, the user is not included in the global whitelist. The SMSF is configured to allow the MO/MT message on determining that the user is included in the global whitelist and derive a public land mobile network (PLMN) identification (ID) from the MO/MT request on determining that the user is not included in the global whitelist. The PLMN-ID include combination of a mobile country code (MCC), a mobile network code (MNC), a tracking area code (TAC). The SMSF is configured to verify whether the MO/MT message is barred in a defined cell ID from a plurality of cell IDs in the PLMN using a data structure-cell blacklisted (DS-CELLB). The SMSF is configured to verify whether the MO/MT message is barred in the defined cell ID from plurality of cell IDs in the PLMN using a data structure-cell blacklisted (DS-CELLB). On determining that the MO/MT message is barred in the defined cell ID from plurality of cell IDs in the PLMN, the SMSF is configured to bar the MO/MT message. The SMSF is configured to allow the MO/MT message on determining that the MO/MT message is not barred in the defined cell ID from plurality of cell IDs in the PLMN.

In some embodiments, the SMSF is configured to create a dynamic counter for counting a number of MO/MT blocking due to the management blocking for each profile value. The dynamic counter is used for home subscribers and international roamers.

In some embodiments, the dynamic counter is created based on one of an originating PLMN for MO, a terminating PLMN for MT, per international roamer PLMN to provide the values for MO attempted, MT attempted, MO success, MT success, activation attempted, activation success, MO blocked, MT blocked, context get and combination.

In some embodiments, the SMSF is configured to determine whether the PLMN is whitelisted, or block listed for the MO/MT request by using a data structure-public land mobile network whitelisted (DS-PLMNW) or a data structure-public land mobile network blacklisted (DS-PLMNB).

In yet another exemplary embodiment, a short message service function (SMSF) is described. The SMSF is configured to receive a mobile originating/mobile terminating (MO/MT) request from one user of the plurality of users. The request includes a general public subscription identifier (GPSI) of the user. The SMSF is further configured to determine whether the user is included in a global whitelist using a data structure global whitelisting (DS-GW) flag. The SMSF is configured to allow the MO/MT message on determining that the user is included in the global whitelist and derive a public land mobile network (PLMN) identification (ID) from the MO/MT request on determining that the user is not included in the global whitelist. The PLMN-ID include combination of a mobile country code (MCC), a mobile network code (MNC), a tracking area code (TAC). The SMSF is configured to verify whether the MO/MT message is barred in a defined cell ID from a plurality of cell IDs in the PLMN using a data structure-cell blacklisted (DS-CELLB). The SMSF is configured to verify whether the MO/MT message is barred in the defined cell ID from plurality of cell IDs in the PLMN using a data structure-cell blacklisted (DS-CELLB). On determining that the MO/MT message is barred in the defined cell ID from plurality of cell IDs in the PLMN, the SMSF is configured to bar the MO/MT message. The SMSF is configured to allow the MO/MT message on determining that the MO/MT message is not barred in the defined cell ID from plurality of cell IDs in the PLMN.

In some embodiments, the SMSF is configured to create a dynamic counter for counting a number of MO/MT blocking due to the management blocking for each profile value. The dynamic counter is used for home subscribers and international roamers.

In some embodiments, the dynamic counter is created based on one of an originating PLMN for MO, a terminating PLMN for MT, per international roamer PLMN to provide the values for MO attempted, MT attempted, MO success, MT success, activation attempted, activation success, MO blocked, MT blocked, context get and combination.

In some embodiments, the SMSF is configured to determine whether the PLMN is whitelisted, or block listed for the MO/MT request by using a data structure-public land mobile network whitelisted (DS-PLMNW) or a data structure-public land mobile network blacklisted (DS-PLMNB).

The foregoing general description of the illustrative embodiments and the following detailed description thereof are merely exemplary aspects of the teachings of this disclosure and are not restrictive.

### OBJECTS OF THE INVENTION

It is an object of the present disclosure to provide a system and a method that provides an efficient way to handle logical barring of various devices from sending and receiving messages in a network.

It is an object of the present disclosure to provide a system and a method that facilitates barring of selective users in a defined cell-identification (ID) of a public land mobile network (PLMN).

It is an object of the present disclosure to provide a system and a method that is directed towards barring of cell IDs in certain pre-defined areas and provides a flexible solution to block certain cell-IDs in the PLMN from using message related services.

It is an object of the present disclosure to provide a system and a method where a short message service function (SMSF) verifies if a mobile originating/mobile terminating (MO/MT) message is barred in a defined cell-ID in the PLMN.

It is an object of the present disclosure to provide a system and a method that enhances the security and tracing related aspects associated with the devices.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system (108), in accordance with an embodiment of the present disclosure.

FIG. 2 illustrates an exemplary block diagram (200) of a proposed system (108), in accordance with an embodiment of the present disclosure.

FIG. 3 illustrates an exemplary flow diagram (300) of a mobile originating (MO) request, in accordance with an embodiment of the present disclosure.

FIG. 4 illustrates an exemplary computer system (400) in which or with which the embodiments of the present disclosure may be implemented.

The foregoing shall be more apparent from the following more detailed description of the disclosure.

### BRIEF DESCRIPTION OF THE INVENTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

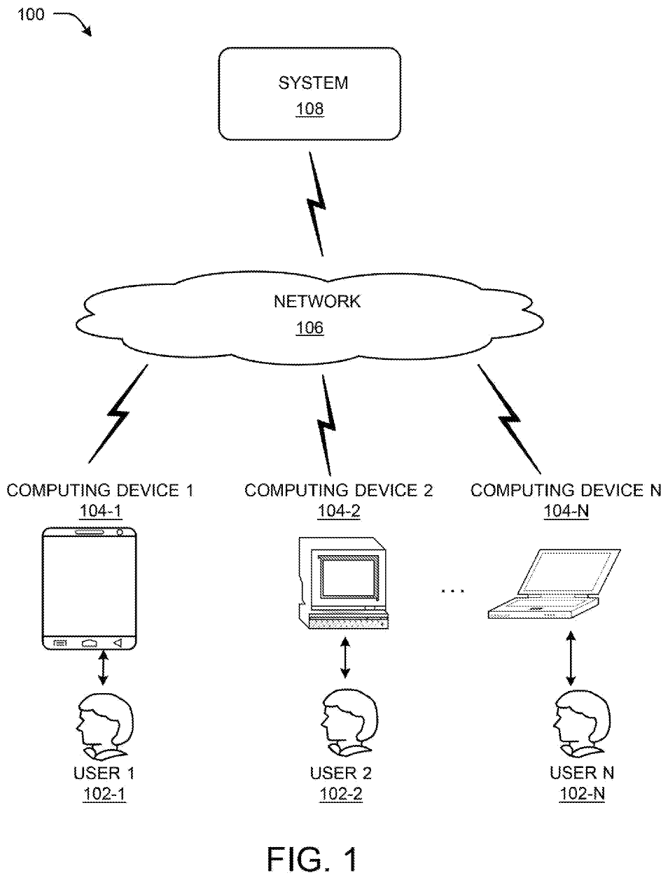

The various embodiments throughout the disclosure will be explained in more detail with reference to FIGS. 1-4.

FIG. 1 illustrates an exemplary network architecture (100) of a proposed system (108), in accordance with an embodiment of the present disclosure.

As illustrated in FIG. 1, one or more computing devices (104-1, 104-2 . . . 104-N) may be connected to the proposed system (108) through a network (106). A person of ordinary skill in the art will understand that the one or more computing devices (104-1, 104-2 . . . 104-N) may be collectively referred as computing devices (104) and individually referred as a computing device (104). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure. One or more users (102-1, 102-2 . . . 102-N) may provide one or more requests to the system (108). In an embodiment, the one or more requests may be based on a mobile originating (MO) or a mobile terminating (MT) message. The mobile originating (MO) may refer to user equipment initiating a communication session or action, for example, request (call or message) being sent from the user equipment. The request is originated at the user end. The mobile terminating (MT) may refer communication session or action directed towards a user equipment, for example, the request (call or message) being sent to the user equipment. The message is terminated at the user end.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the system (108) may receive the one or more requests from the users (102) via the computing devices (104). The system (108) may be interchangeably referred as a short message service function (SMSF) node. The system (108) may include one or more data structures for maintaining a whitelist subscriber list and a blocklist subscriber list based on the one or more users (102). In an embodiment, the whitelist subscriber list and the blocklist subscriber list may be updated by the system (108) on a regular basis. The system (108) may facilitate a cell-identification (ID) barring mechanism for both the MO and the MT message associated with the UE (104) via the one or more data structures.

In an embodiment, the system (108) may derive the cell-ID, a public land mobile network (PLMN), and a general public subscription identifier (GPSI) information from the received one or more requests at the time of the UE (104) attachment in the network (106).

In an embodiment, the system (108) may generate one or more profiles based on the UE (104) attachment in the network (106).

In an embodiment, the system (108) may generate one or more statistics associated with the cell-ID barring mechanism.

In an embodiment, the system (108) may generate a management blocking mechanism associated with the one or more requests.

Further, in an embodiment, the system (108) may generate one or more call data records (CDRs) associated with the management blocking mechanism and the cell-ID barring mechanism.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

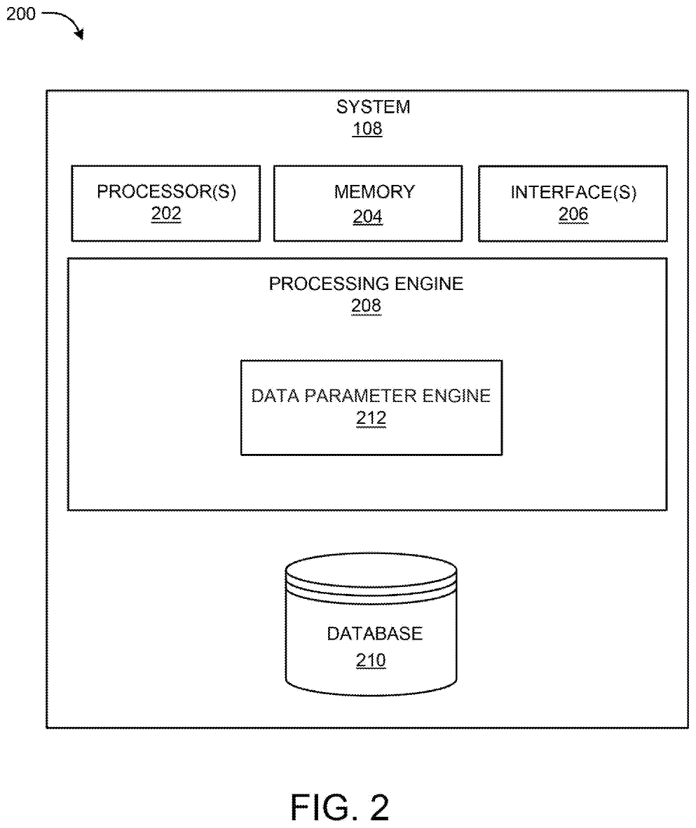

FIG. 2 illustrates an exemplary block diagram (200) of a proposed system (108), in accordance with an embodiment of the present disclosure.

Referring to FIG. 2, in an embodiment, the system (108) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, processing engine(s) (208) including a data parameter engine (212), and a database (210).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may receive one or more requests via the data parameter engine (212). The one or more requests may be received from users (102) via computing devices (104). The processor (202) may store the one or more requests in the database (210).

In an embodiment, the processor (202) may include one or more data structures for maintaining a whitelist subscriber list and a blocklist subscriber list. The whitelist subscriber list and the blocklist subscriber list may be updated by the processor (202) on a regular basis. The processor (202) may facilitate a cell-ID barring mechanism for both an MO and an MT message associated with the computing device (104) via the one or more data structures.

In an embodiment, the processor (202) may derive the cell-ID, PLMN, and GPSI information from the received one or more requests at the time of the UE (104) attachment in a network (106).

In an embodiment, the processor (202) may generate one or more profiles based on the UE (104) attachment in the network (106).

In an embodiment, the processor (202) may generate one or more statistics associated with the cell-ID barring mechanism.

In an embodiment, the processor (202) may generate a management blocking mechanism associated with the one or more requests.

Further, in an embodiment, the processor (202) may generate one or more CDRs associated with the management blocking mechanism and the cell-ID barring mechanism.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

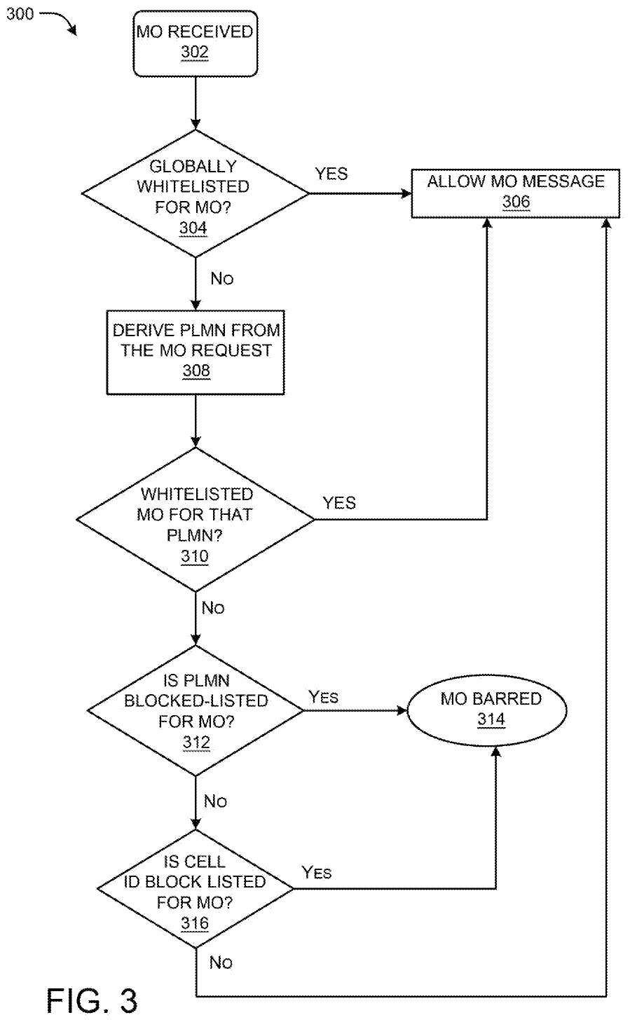

FIG. 3 illustrates an exemplary flow diagram (300) of an MO message, in accordance with an embodiment of the present disclosure.

As illustrated in FIG. 3, the flow diagram (300) of an MO request may include the following steps. In an embodiment, similar steps may be used by an MT request.

At step 302: The disclosed system (108) may receive an MO request from a user (102). The MO request may include the GPSI of the user (102).

At step 304: The system (108) may determine if the user (102) is included in a global whitelist.

At step 306: Based on a positive determination received from step 304, the system (108) may allow the MO request/message to be delivered.

At step 308: Based on a negative determination received from step 304, the system (108) may derive the PLMN from the MO request.

At step 310: The system (108) may determine if the PLMN is whitelisted for the MO request. Based on a positive determination, the system (108) may continue with step 306.

At step 312: Based on a negative determination from step 310, the system (108) may determine if PLMN is block listed for the MO request.

At step 314: Based on a positive determination from step 312, the MO request may be barred.

At step 316: Based on a negative determination from step 312, the system (108) may determine if cell-ID is block listed for the MO request. Based on the positive determination, the MO request may be barred at step 314. Based on a negative determination, the system (108) may continue with step 306.

In an embodiment, the system/SMSF (108) may facilitate cell-ID barring for both MO and MT messages with the help of four internal data structures. Two of the data structures may be used for maintaining a list of all whitelisted subscribers (GPSI used as UE identifier), and the rest for maintaining a list of all block-listed PLMN or cell-IDs. These data structures may be populated at the time of whitelisting or block-listing provisioning. The data structures may be as follows:

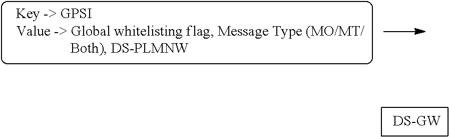

In an embodiment, the SMSF (108) may use a DS-GW data structure to check if a defined GPSI is globally whitelisted. If the SMSF (108) finds that the GPSI is globally whitelisted, then it may allow the MO/MT message. If not, the SMSF (108) may query the DS-PLMNW data structure for that GPSI. In an example, the DS-PLMNW may refer to collection of cell IDs that are whitelisted in PLMN.

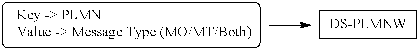

In an embodiment, the SMSF (108) may use the DS-PLMNW data structure to check if a defined GPSI is whitelisted in the PLMN from which the SMSF (108) receives the MO message or to which SMSF (108) is about to forward the MT message. If the GPSI is whitelisted for that PLMN, the SMSF (108) may allow the MO/MT message. If not, the SMSF (108) may go on to query the DS-PLMNB data structure for block listing.

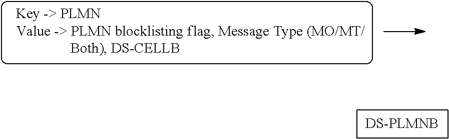

In an embodiment, the SMSF (108) may use a DS-PLMNB to verify if the MO/MT messages are barred for that PLMN. If the SMSF (108) finds that PLMN is barred for a short message service (SMS), the message may be barred straightaway. If not, the SMSF (108) may query a DS-CELLB for message barring in the cell-ID. In an example, the DS-CELLB is a database or repository of cell IDs that are blacklisted for various reasons including, but are not limited to, lost/stolen device, unauthorized access, regulatory compliance including location based restrictions, and public safety. The DS-CELLB may be created and maintained by service providers or can be shared from state authorities maintaining the DS-CELLB. In an example, the DS-PLMNB may refer to collection of cell IDs that are blacklisted in PLMN.

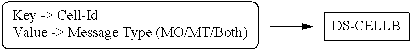

In an embodiment, the SMSF (108) may use a DS-CELLB to verify if the MO/MT messages are barred in a defined cell-ID in the PLMN. If the SMSF (108) finds that the UE cell-ID is barred for an SMS, the message may be barred straightaway. If not, the SMSF (108) may allow the MO/MT message. Further, the SMSF (108) may be able to provide a range of cell IDs per PLMN for which MO/MT may be blocked. The user (102) may provide the list of cell IDs in possible ways, but not limited to, individual cell IDs, i.e. an Evolved UMTS Terrestrial Radio Access Network (E-UTRAN) cell identifier (ECI)/new radio cell identity (NCI), list of cell IDs (ECI/NCI), mobile country code (MCC)+mobile network code (MNC)+type allocation code (TAC)+ECI/NCI individual list of MCC+MNC+TAC+ECI/NCI.

In an embodiment, the SMSF (108) may derive the cell-ID, PLMN, and GPSI information from an activation request received at the time of UE (104) attachment in 5G network. Further, the SMSF (108) may generate following statistics as well.
Total number of blocked messages
Total number of blocked MO messages
Total number of blocked MT messages.
Number of blocked messages for the PLMN.
Number of blocked MO messages for the PLMN
Number of blocked MT messages for the PLMN
Number of blocked messages for the cell-ID
Number of blocked MO messages for the cell-ID
Number of blocked MT messages for a cell-ID
Total number of whitelisted messages
Total number of whitelisted MO messages
Total number of whitelisted MT messages
Number of whitelisted messages for the subscriber (GPSI)
Number of whitelisted MO messages for the subscriber (GPSI)
Number of whitelisted MT messages for the subscriber (GPSI)
Number of whitelisted messages in a PLMN for the subscriber
Number of whitelisted MO messages in a PLMN for the subscriber
Number of whitelisted MT messages in a PLMN for the subscriber.

In an embodiment, the SMSF (108) may provide the range of cell-IDs per PLMN for which MO/MT may be blocked. The SMSF (108) may provide the whitelisting functionalities based on mobile station integrated services digital network (MSISDN) and/or a command line interface (CLI) and an ability to create CDRs for blocking. Appropriate commands may be available for supporting above functions for both individual provisioning as well as bulk provisioning. Provisioning may include Create/Modify/Append/Delete All/Delete Partial depending upon the user requirements. The SMSF (108) may also provide logging functionality for blocking and corresponding counters may be available for cell-ID based blocking. The cell-ID based blocking feature may not impact existing features and functions of the SMSF (108). Further, the management blocking feature may be supported that may relate to a group of pre-defined users (102) in any cell-ID.

In an embodiment, the management blocking may also be known as a unified data manager (UDM) profile based blocking. The SMSF (108) may interact with the UDM to get the SMS profile of the subscriber, which may include fields such as, but not limited to, “mtSmsSubscribed”/“mtSmsBarringAll”/“mtSmsBarringRoaming”/“moSmsSubs cribed”/“moSmsBarringAll”/“moSmsbarringRoaming.” The SMSF (108) may have a capability to honour the blocking based on the subscriber UDM profile. For the purpose, the SMSF (108) may provide a user configurable runtime flag to enable or disable the “management blocking” feature. In case “mtSmsSubscribed” is set to “False” or “mtSmsBarringAll” is set to “True,” then the SMSF (108) may not allow the MT SMS for the subscriber. Similarly, if “moSmsSubscribed” is set to “False” or “moSmsBarringAll” is set to “True,” then the SMSF (108) may not allow the MO SMS for the subscriber. In case the subscriber is currently roaming (serving PLMN is not matching the subscriber permanent identifier (SUPI)/international mobile subscriber identity (IMSI) and if “mtSmsBarringRoaming” is set to “True,” then also the MT SMS may not be allowed for the subscriber.

Similarly, if the subscriber is roaming and “moSmsbarringRoaming” is set to “True,” then MO SMS may not be allowed by the SMSF (108). These rules for blocking may not require any specific list of MSISDN/CLI to be created and rather may only be dependent upon the fact that the “management blocking” feature is enabled. In an embodiment, the SMSF (108) may subscribe to the UDM to get the latest subscriber profile, which may be used for making the blocking decision for management blocking feature. In case profile is not available at the SMSF (108), then the SMSF (108) may fetch the profile from the UDM and also subscribe to a profile change from the UDM before making the blocking decision.

In an embodiment, the SMSF (108) may also write the CDRs for management blocking similar to the CDRs to be written for the cell-ID based blocking bit with a different status code for identifying the management blocking. Also, the SMSF (108) may create the counter for number of MO/MT blocking due to the management blocking (separately) for each profile value and may be separate for international roamers as well. The counter may be a dynamic counter to count a number of MO/MT responsive to a management blocking feature for profiles. The SMSF (108) may create an extensible data record (XDR)/appropriate logs/alerts based on a threshold level. Further, the SMSF (108) may ensure that the “management blocking” feature flag at the SMSF (108) instance and cluster level survives the restart. The SMSF (108) may include the flag value as a part of a backup and restore operations.

In an embodiment, the SMSF (108) may provide a flag which by default may be set to false based on a blocking mechanism sent towards vProbe or not. It may be understood that vProbe may be an XDR analytical solution. In case the flag is false, the SDR for blocking may not be sent towards vProbe. In case the flag is true, the SDRs generated for blocking may be sent towards vProbe. Further, the SDR may be able to distinguish between various types of blocking depending upon a use case. As an example for cell-ID blocking, specific code may be given, whereas for management blocking for MO SMS, another status code may be provided.

In an exemplary embodiment, the PLMN (MCC+MNC) home user (or a specific list of MSISDN/IMSI) may not be able to send the message towards specific country code (B Party starting from specific CC).

In an exemplary embodiment, any user (102) (or a specific list of MSISDN/IMSI) currently roaming into a specific PLMN (MCC+MNC) may not be able to send the message towards a specific country code (B Party starting from specific CC).

In an exemplary embodiment, the PLMN (MCC+MNC) home user (or a specific list of MSISDN/IMSI) may not be able to receive the message from a specific country code (A Party starting from specific CC).

In an exemplary embodiment, any user (102) (or a specific list of MSISDN/IMSI) currently roaming into specific PLMN (MCC+MNC) may not be able to receive a message from a specific country code (A Party starting from specific CC).

In an embodiment, the CDR may be written by the SMSF (108) based on the whitelisting and the block listing. The new CDR files may not be required to be created but rather the existing CDR files may be used i.e. CDR file used for International roamers may be used for holding the International roamer blocking CDRs as well. Similarly, the CDR file used for subscribers may be used for holding the blocking CDR for the subscribers.

In an embodiment, the use cases may survive a restart of a single SMSF instance or a complete cluster restart. Further, the SMSF (108) may provide the mechanism to backup and restore lists in case needed. Auto backup (scheduled) may not be possible along with a manual restore function.

In an embodiment, the SMSF (108) may provide the appropriate SDR records for cell-ID blocking and for a special use case blocking scenario. The SMSF (108) may also audit the feature at regular intervals and in case of unavailability of the feature, the SMSF (108) may be able to create appropriate logs and generate an appropriate alert.

In an embodiment, the SMSF (108) may be enhanced to provide the support for dynamic counters that are generated based on a combination of fields such as, but not limited to, an originating PLMN (for MO), a terminating PLMN (for MT), Per International roamer PLMN to provide the values for MO Attempted, MT Attempted, MO Success, MT Success, Activation Attempted, Activation Success, MO Blocked, MT Blocked, Context Get, etc. These dynamic counters may be used for not only monitoring a granular performance per PLMN (for both home subscribers and international roamers), they may also be converted to key performance indicators (KPIs) for monitoring. These dynamic counters may be integrated with an integrated performance management (IPM) module directly to maximize benefits associated.

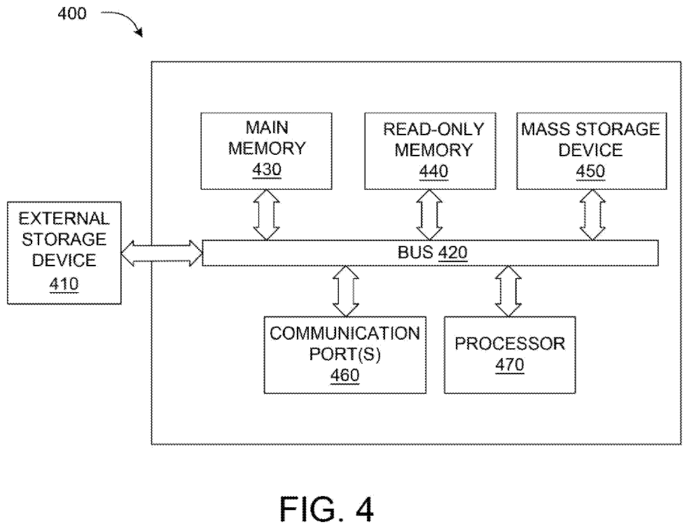

FIG. 4 illustrates an exemplary computer system (400) in which or with which embodiments of the present disclosure may be implemented.

As shown in FIG. 4, the computer system (400) may include an external storage device (410), a bus (420), a main memory (430), a read-only memory (440), a mass storage device (450), a communication port(s) (460), and a processor (470). A person skilled in the art will appreciate that the computer system (400) may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (460) may be chosen depending on a network, such as a Local Area Network (LAN), Wide Area Network (WAN), or any network to which the computer system (400) connects

In an embodiment, the main memory (430) may be Random Access Memory (RAM), or any other dynamic storage device commonly known in the art. The read-only memory (440) may be any static storage device(s) e.g., but not limited to, a Programmable Read Only Memory (PROM) chip for storing static information e.g., start-up or basic input/output system (BIOS) instructions for the processor (470). The mass storage device (450) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (420) may communicatively couple the processor(s) (470) with the other memory, storage, and communication blocks. The bus (420) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (470) to the computer system (400).

In another embodiment, operator and administrative interfaces, e.g., a display, keyboard, and cursor control device may also be coupled to the bus (420) to support direct operator interaction with the computer system (400). Other operator and administrative interfaces can be provided through network connections connected through the communication port(s) (460). Components described above are meant only to exemplify various possibilities. In no way should the aforementioned exemplary computer system (400) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides an efficient way to handle logical barring of various devices from sending and receiving messages in a network.

The present disclosure facilitates barring of selective users in a defined cell-identification (ID) of a public land mobile network (PLMN).

The present disclosure is directed towards barring of cell IDs in certain pre-defined areas and provides a flexible solution to block certain cell IDs in the PLMN from using message related services.

The present disclosure provides a system and a method where a short message service function (SMSF) verifies if a mobile originating/mobile terminating (MO/MT) message is barred in a defined cell-ID in the PLMN.

The present disclosure provides a secured and robust communication system.

The present disclosure provides a system and a method that enhances the security and tracing related aspects associated with the devices.

We claim:

1. A method for cell identification (ID) barring to restrict one of plurality of users (102) from sending and receiving messages in a network by a short message service function (SMSF) (108), the method comprising:
receiving a mobile originating/mobile terminating (MO/MT) request from a user (102) of the plurality of users (102), wherein the request includes a general public subscription identifier (GPSI) of the user (102);
responsive to the MO/MT request, determining whether the user (102) is included in a global whitelist using a data structure global whitelisting (DS-GW) flag, wherein when the DS-GW flag is set to true, the user (102) is included in the global whitelist and when the DS-GW flag is set to false, the user (102) is not included in the global whitelist;
on determining that the user (102) is included in the global whitelist, allowing MO/MT message;
on determining that the user (102) is not included in the global whitelist, deriving a public land mobile network (PLMN) identification (ID) from the MO/MT request, wherein the PLMN-ID comprises a mobile country code (MCC), a mobile network code (MNC), and a tracking area code (TAC);
verifying whether the MO/MT message is barred in a defined cell ID from a plurality of cell IDs in the PLMN using a data structure-cell blacklisted (DS-CELLB); and
on determining that the MO/MT message is barred in the defined cell ID from the plurality of cell IDs in the PLMN, barring the MO/MT message, or on determining that the MO/MT message is not barred in the defined cell ID from the plurality of cell IDs in the PLMN, allowing the MO/MT message.

2. The method of claim 1 further comprising creating a dynamic counter for counting a number of MO/MT blocking based on a management blocking parameter for MO/MT blocking for each profile, wherein the dynamic counter is used for home subscribers and international roamers.

3. The method of claim 1, wherein the dynamic counter is created based on one of an originating PLMN for MO, a terminating PLMN for MT, per international roamer PLMN to provide the values for MO attempted, MT attempted, MO success, MT success, activation attempted, activation success, MO blocked, MT blocked, context get and combination.

4. The method of claim 1 further comprising determining whether the PLMN is whitelisted or block listed for the MO/MT request by using a data structure-public land mobile network whitelisted (DS-PLMNW) or a data structure-public land mobile network blacklisted (DS-PLMNB).

5. A system for cell identification (ID) barring to restrict one of plurality of users (102) from sending and receiving messages in a network, the system comprising a short message service function (SMSF) (108), the SMSF (108) is configured to:
receive a mobile originating/mobile terminating (MO/MT) request from a user (102) of the plurality of users (102), wherein the request includes a general public subscription identifier (GPSI) of the user (102);
responsive to the MO/MT request, determine whether the user (102) is included in a global whitelist using a data structure global whitelisting (DS-GW) flag, wherein when the DS-GW flag is set to true, the user (102) is included in the global whitelist and when the DS-GW flag is set to false, the user (102) is not included in the global whitelist;
on determining that the user (102) is included in the global whitelist, allow MO/MT message;
on determining that the user (102) is not included in the global whitelist, derive a public land mobile network (PLMN) identification (ID) from the MO/MT request, wherein the PLMN-ID include combination of a mobile country code (MCC), a mobile network code (MNC), a tracking area code (TAC);
verify whether the MO/MT message is barred in a defined cell ID from a plurality of cell IDs in the PLMN using a data structure-cell blacklisted (DS-CELLB); and
on determining that the MO/MT message is barred in the defined cell ID from the plurality of cell IDs in the PLMN, bar the MO/MT message, or configure the SMSF (108) to allow the MO/MT message on determining that the MO/MT message is not barred in the defined cell ID from the plurality of cell IDs in the PLMN.

6. The system of claim 5, the SMSF (108) is configured to create a dynamic counter for counting a number of MO/MT blocking based on management blocking parameter for each profile, wherein the dynamic counter is used for home subscribers and international roamers.

7. The system of claim 5, wherein the dynamic counter is created based on one of an originating PLMN for MO, a terminating PLMN for MT, per international roamer PLMN to provide the values for MO attempted, MT attempted, MO success, MT success, activation attempted, activation success, MO blocked, MT blocked, context get and combination.

8. The system of claim 5, the SMSF (108) is configured to determine whether the PLMN is whitelisted or block listed for the MO/MT request by using a data structure-public land mobile network whitelisted (DS-PLMNW) or a data structure-public land mobile network blacklisted (DS-PLMNB).

9. A short message service function (SMSF) (108), the SMSF (108) is configured to:
receive a mobile originating/mobile terminating (MO/MT) request from a user (102) of the plurality of users (102), wherein the request includes general public subscription identifier (GPSI) of the user (102);
determine whether the user (102) is included in a global whitelist using a data structure global whitelisting (DS-GW) flag, wherein when the DS-GW flag is set to true, the user (102) is included in the global whitelist and when the DS-GW flag is set to false, the user (102) is not included in the global whitelist;
on determining that the user (102) is included in the global whitelist, allow MO/MT message;
on determining that the user (102) is not included in the global whitelist, derive a public land mobile network (PLMN) identification (ID) from the MO/MT request, wherein the PLMN-ID include combination of a mobile country code (MCC), a mobile network code (MNC), a tracking area code (TAC);
verify whether the MO/MT message is barred in a defined cell ID from a plurality of cell IDs in the PLMN using a data structure-cell blacklisted (DS-CELLB); and
on determining that the MO/MT message is barred in the defined cell ID from the plurality of cell IDs in the PLMN, bar the MO/MT message, wherein the SMSF (108) is configured to allow the MO/MT message on determining that the MO/MT message is not barred in the defined cell ID from the plurality of cell IDs in the PLMN.

10. The SMSF (108) of claim 9, the SMSF (108) is configured to: create a dynamic counter for counting a number of MO/MT blocking due to management blocking for each profile value, wherein the dynamic counter is used for home subscribers and international roamers.

11. The SMSF (108) of claim 9, wherein the dynamic counter is created based on one of an originating PLMN for MO, a terminating PLMN for MT, per international roamer PLMN to provide the values for MO attempted, MT attempted, MO success, MT success, activation attempted, activation success, MO blocked, MT blocked, context get and combination.

12. The SMSF (108) of claim 9, the SMSF (108) is configured to determine whether the PLMN is whitelisted, or block listed for the MO/MT request by using a data structure-public land mobile network whitelisted (DS-PLMNW) or a data structure-public land mobile network blacklisted (DS-PLMNB).

13. A computer program product comprising a non-transitory computer-readable medium comprising instructions that, when executed by one or more processors, cause the one or more processors to execute a method for cell identification (ID) barring to restrict one of plurality of users (102) from sending and receiving messages in a network by a short message service function (SMSF) (108), the method comprising:
receiving a mobile originating/mobile terminating (MO/MT) request from a user (102) of the plurality of users (102), wherein the request includes a general public subscription identifier (GPSI) of the user (102);
responsive to the MO/MT request, determining whether the user (102) is included in a global whitelist using a data structure global whitelisting (DS-GW) flag, wherein when the DS-GW flag is set to true, the user (102) is included in the global whitelist and when the DS-GW flag is set to false, the user (102) is not included in the global whitelist;
on determining that the user (102) is included in the global whitelist, allowing MO/MT message;
on determining that the user (102) is not included in the global whitelist, deriving a public land mobile network (PLMN) identification (ID) from the MO/MT request, wherein the PLMN-ID include combination of a mobile country code (MCC), a mobile network code (MNC), a tracking area code (TAC);
verifying whether the MO/MT message is barred in a defined cell ID from a plurality of cell IDs in the PLMN using a data structure-cell blacklisted (DS-CELLB); and
on determining that the MO/MT message is barred in the defined cell ID from the plurality of cell IDs in the PLMN, barring the MO/MT message, or on determining that the MO/MT message is not barred in the defined cell ID from the plurality of cell IDs in the PLMN, allowing the MO/MT message.
